(19) United States
(12) Patent Application Publication
(10) Pub. No.: US 2015/0167957 A1
(43) Pub. Date: Jun. 18, 2015

(54) The LED Light Has Multiple Functions

(71) Applicant: Tseng-Lu Chien, Walnut, CA (US)

(72) Inventor: Tseng-Lu Chien, Walnut, CA (US)

(21) Appl. No.: 14/106,015

(22) Filed: Dec. 13, 2013

(51) Int. Cl. F21V 33/00; F21S 9/02

(52) U.S. Cl. CPC F21V 33/0076; F21S 9/024; F21W 2111/10

(57) ABSTRACT

The current invention for The LED light has build-in or add-on or snap-on the said sound means to allow people can use the sound means such as whistle to make big volume sound to be heard by other people while people meet bad environment, condition such as earthquake, flood, Typhoon, Hurricane, tornado, fire, bombing, Tsunami, terrorist attack . . . etc. The said LED light is non-portable device which install on certain location, position, area for a period of time.

The current invention are CIP for co-pending filing for Ser. No. 13/402,247 The LED Device has Build-in Removable LED lights file on 2012 which are The current invention is co-inventor's Division filing of the U.S. Pat. No. 8,083,376 and co-inventor's prior art U.S. Pat. No. 6,179,431 6 EL flash light. The current invention also is continuously of co-pending filing for Ser. No. 12/938,628 LED light fixture has outlets and removable LED unit(s) and continuously filing for Ser. No. 12/887,700 (now is U.S. Pat. No. 8,083,392) and

CIP of co-pending Ser. No. 13/910,295 Wall cover has LED light & USB charger which is CIP filing of U.S. Pat. No. 7,318,653 for Wall cover has build in LED light and Outlet.

The current invention is co-inventor's Division filing of the U.S. Pat. No. 8,083,376 and co-inventor's prior art U.S. Pat. No. 6,179,431 6 EL flash light. The current invention also is continuously of co-pending filing for Ser. No. 12/938,628 LED light fixture has outlets and removable LED unit(s) and continuously filing for Ser. No. 12/887,700 (now is U.S. Pat. No. 8,083,392)

### BACKGROUND

The current market LED light including the flash light, Power Fail light, Light bar, light device has LED-element(s) as light source to replace the out-of date Incandescent Bulbs for less power consumption, compact size, long burn time, long life for light source . . . etc. All lake of sound means to help people to create big volume sound to be heard while face bad situations.

Basing on these co-inveot's issued patent including for the Power fail light U.S. Pat. No. 8,083,376 features has power saving, compact size, longer burn-time while applied LED as light source instead of out-of-date incandescent bulbs, so the size of the flash light, power fail light, light bar, light device become very small. All these categories products in market become very compact such as cigarette lighter size, or mini size of hot-dog size which are too small and normally can not find where are the flash light, or power fail light, or light bar, or LED device while people want to use.

However, The categories of flash light, power fail light, light bar, LED device people still think the old bulky size as the flash light, power fail light, light bar, or LED device such as house phone still keep same size, no one make like mini size hot-dog size because the people head size from ear to mouth still not reduce to mini size hot-dog. Same of Flash light, Power fail light, Light Bar, LED device, the traditional size with bulky size which are fit for people hand size and good for palm holding to let people feel safety while using these device(s) on emergency or some hazard time. The categories of flash light, power fail light, light bar, LED device has traditional image deep inside human memory so it is not good to make compact size at all.

The current invention apply the LED element(s) as issued U.S. Pat. No. 8,083,376 and earlier issued U.S. Pat. No. 7,318,653 as light source to keep the power saving, long burn time, light source long life . . . etc. however, keep the same bulky size and make one housing with more than one piece of LED lights which may said at least one big one for adult and at least one small LED light for children or kids for their smaller hand to hold it, so can keep the traditional bulky size but with build-in at least more than one LED lights.

The removable or permanent build in the said sound means on the current inventor is the very help for people to save their life.

Hereafter on the drawing, details discussion and claims will list the current inventions more features below:

It is appreciated the current invention has all above discussed co-pending or issued patent's drawing, details description and content are still been the parent filing of the current invention and all such drawing, detail description, contents should be still fall within the scope of the current invention and not limited to the current drawing, details description, content.

### BRIEF DESCRIPTION OF THE DRAWINGS

FIGS. 1, 1A, and 1C are side views of an LED light according to a first preferred embodiment of the invention.

FIG. 1B is a perspective view of the LED light of FIGS. 1, 1A, and 1C.

FIGS. 2, 3, and 4B are exploded perspective views showing details of the preferred embodiment of FIGS. 1 and 1A-1C.

FIG. 4A is a perspective view showing further details of the embodiment of FIGS. 1 and 1A-1C.

FIGS. 5A and 5B are front views of a power fail light in accordance with second and third preferred embodiments of the invention.

FIGS. 6A and 6B are respective front and perspective views of a power fail light in accordance with fourth and fifth preferred embodiments.

FIGS. 7A to 7F are respective front and perspective views of sixth to eleventh preferred embodiments of the invention.

### DETAILED DESCRIPTION OF THE PREFERRED EMBODIMENTS

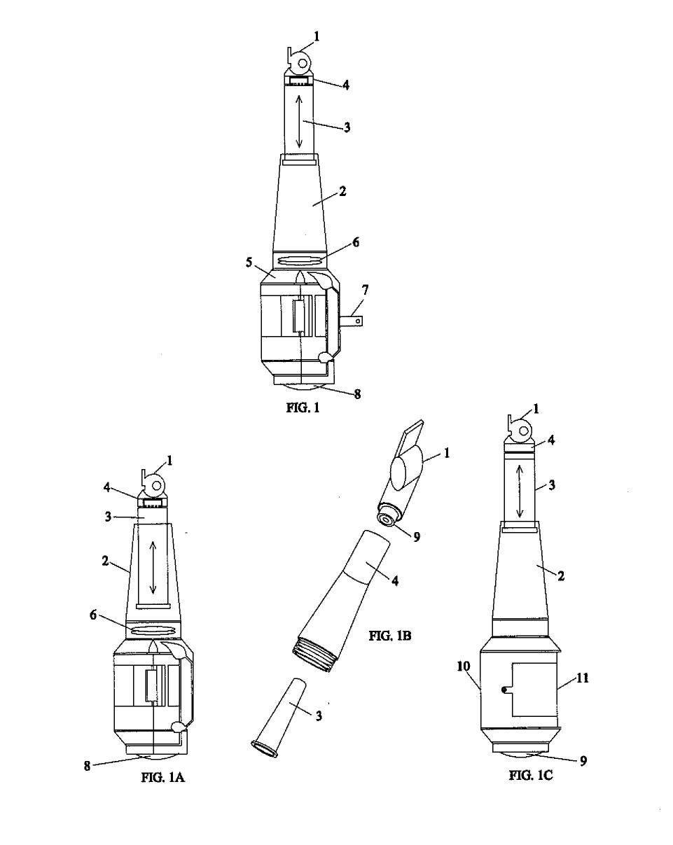

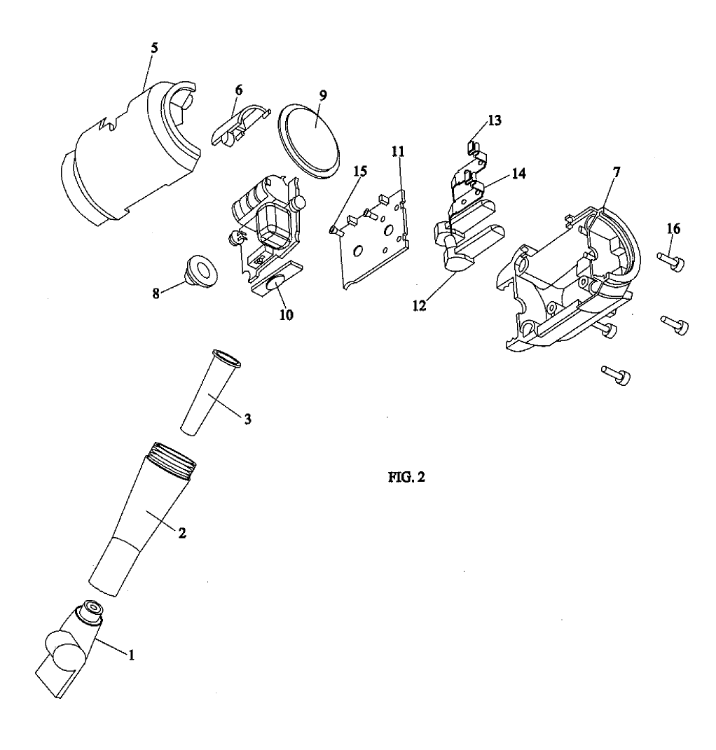

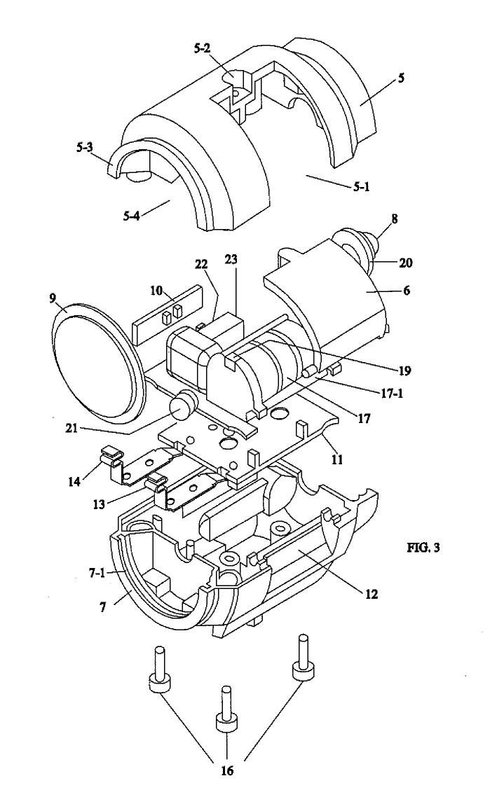

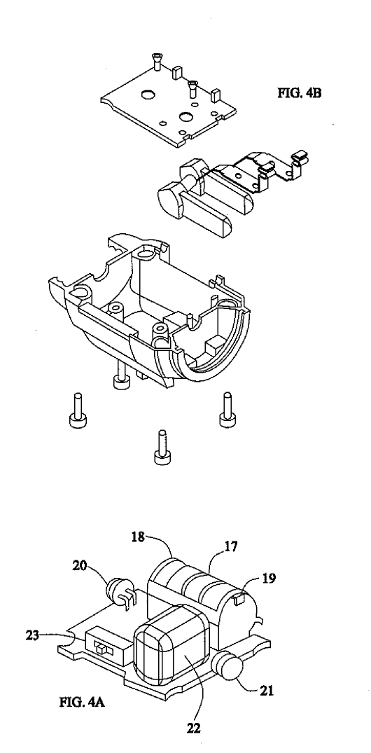

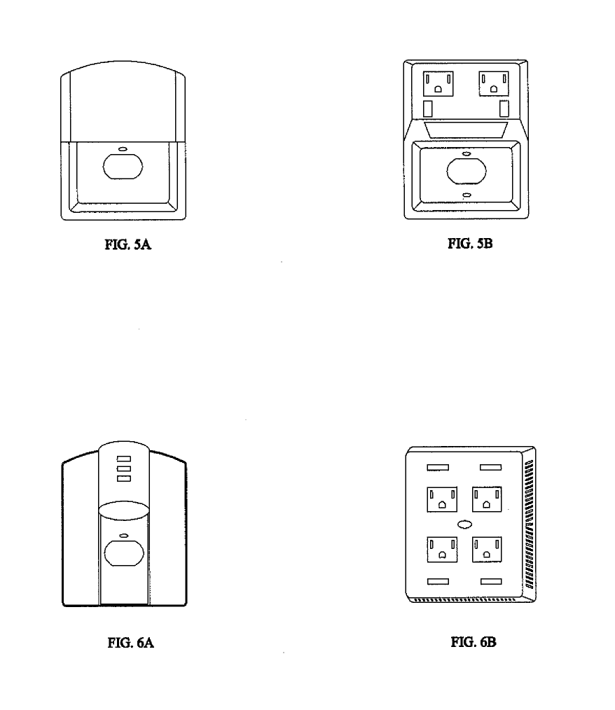

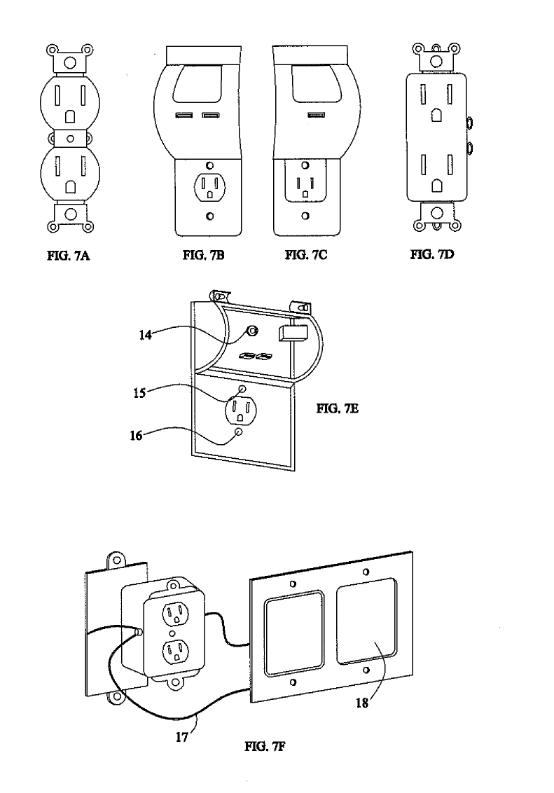

1. From FIG. 1 and FIG. 1-2 and FIG. 1-3 and FIG. 1-3: disclosure the 1^{st} embodiment of LED Power fail light has Pt LED as Night light to offer the area illumination from the extendable tube and body tube while the foldable prong means connect with wall outlets power source to get power and under predetermined function by electric control means. The said 2^{nd} LED will turn on automatically or manual or off by circuit means. The said 1^{st} and 2^{nd} LED further incorporated selected electric control means may selected from group combination for sensor, switch, IC, motion sensor, infra-red sensor, blue tooth, remote control or other electric or mechanical means available from market place. The said LED power fail light has sound or siren means which within, add-on, fix-on, install on the said housing to allow people use human body to make the super load sound to be heard for far away distance or under building materials.
2. From FIG. 2 and FIG. 3 and FIG. 4 disclosure the 1^{st} embodiment which has detail construction, parts, assembly for the said LED power fail light.
3. From FIG. 5-1, 5-2 and FIG. 6-1, 6-2, disclosure the embodiment 2, 3, 4, 5 for the LED power fail Light in the form of Wall cover as main construction which can replace the existing wall cover plate and simple fasten the current invention wall cover LED light on the wall existing outlets's holes for standard inner kits has 2 oval-like outlet has 1 center and 2 top/low holes or for the decora inner kits has rectangular shape outlets only has 2 top/low holes. The current invention wall cover LED light not only supply the area illumination for any purpose or applications as market available LED light device by 1^{st} LED but also supply the light by 2^{nd} LED as emergency light, power fail light, evacuation light for people to use while meet bad environment, condition such as earthquake, flood, Typhoon, Hurricane, tornado, fire, bombing, Tsunami, terrorist attack . . . etc. The optional to add more functions are basing on market requirement which may selected from group combination including outlets, USB Charger, air fresher, 2^{nd} LED light, time piece, project light, movable light, remote control device, infra-red device, blue-tooth device, motion sensor device is still put into consideration.
4. From FIG. 7-1, FIG. 7-2, FIG. 7-3, FIG. 7-4 disclosure the inner unit of the said wall outlet which has (1) Standard type which has 2 oval-like shape receptacle has 1 center and 2 top/low screw holes (2) Decora type which has 2 pcs of receptacles in the rectangular shape but only has 2 top/low screw holes to allow people to fasten the existing wall cover plate or the current invention wall cover LED light.
5. From FIG. 7-5 disclosure the how to make the universal wall cover LED light to fit for the (1) Standard type as FIGS. 7-1 and (2) Decora type outlet's inner unit as FIG. 7-4. The movable plate is needed which are press tight, physical fit, snap-on the said Wall Cover LED light because majority market wall outlet inner kit is 2 over-like receptacle as FIG. 7-1. While consumer has decora type outlet inner unit as FIG. 7-4, then move out the movable plate so the Wall Cover LED light the opening become square as FIG. 7-3.
6. From FIG. 7-1 disclosure the preferred embodiment 10 which the Wall Cover LED light which has the conductive wire to connect with the power source which other embodiment use prong means. The said Wall cover LED light has the 1^{st} LED to form a shaped lighted area or geometric shape light performance not only offer the taste of accent light but also can offer the area illumination. While the power fail the rectangular accent light become a super strong 2^{nd} LED light function as emergency light, power fail light or act as evaluation light. The further more the said Light area is not on the Wall Outlets opening size and shape. The Said the Wall Cover LED light has much bigger size than the wall opening of standard type. The bigger or wider wall cover LED light which can have the extra space which extend from 4 sides of the traditional wall cover to make light performance do not block out original 2 outlets but use conductive wire and assembly by professional electric engineers so still can give people 2 outlets to use. It is appreciated the any alternative, replacement, equal functions design, products, concept still fall within the current invention.
   For Quickly understanding the drawing and current invention's features, Please check below discussion:

The current invention are CIP for co-pending filing for Ser. No. 13/402,247 The LED Device has Build-in Removable LED lights file on 2012 below as Co-#3) which are The current invention is co-inventor's Division filing of the U.S. Pat. No. 8,083,376 (below as Co-#1) and co-inventor's prior art U.S. Pat. No. 6,179,431 6 EL flash light

The current invention also is continuously of co-pending filing for Ser. No. 12/938,628 LED light fixture has outlets and removable LED unit(s) and continuously filing for Ser. No. 12/887,700 (now is U.S. Pat. No. 8,083,392—Below as Co-#2))

and
CIP of co-pending Ser. No. 12/910,295 Wall cover has LED light & USB charger (below as CO-#05) which is CIP filing of U.S. Pat. No. 7,318,653 for Wall cover has build in LED light and Outlet (Below as Co-#4).

The current invention mainly to design a LED light device has at least one of the 1^{st} LED as normal indoor lighting and at least one of the 2^{nd} LED for emergency use as co-inventor's co-#1, #2, #3, #4, #5 prior arts. The current invention add a very important sound or siren means which can allow people to use it while has dangerous situation and let people find injury people locations because sound or siren device can use most less human mouth, hand, foot, legs to make sufficient load sound to big area so can let people find the location. The current invention specified the sound or siren means is not powered by battery or energy storage means because at market all such battery power or energy storage device only can last for very short time because majority use Rechargeable batteries which has bad memory issue or the running hours less than 8 hours. However, the golden rescue is 72 hours so all the market available items is no use. The current invention think the whistle is the best because it only need use human mouse to blow tiny air can make very load volume for miles away people to hear.

To add the human body operate sound or siren device are the best choice and also no one will steal such as whistle at all for all public or indoor place because this is majority for emergency use.

The current invention mainly for 2 application for the Multiple Function LED Light device has at least one for LED light function and at least one for emergency, power fail use for purpose with human body operate sound or siren means to create a big volume to miles away sound to get people attention is the main features.

From US prior art Mr. Bertken's U.S. Pat. Nos. 7,845,820, 8,113,682, 8,186,846 for Flash light with permanent whistle means on TOP. Which is not removable so it is difficult to let people to bite by lips while has emergency use. That is not practically because always have to HOLD the LONG GLOW STICK by hand. It also too long unit so at bad environment there maybe no big space to let people use. The current invention preferred to movable for sound or siren means from LED light device. As long as there has nose tip distance to mouth, can use the movable whistle to call for help. This is main features.

The other difference between Mr. Berken's v.s current invention including:
a. Power source different: Prior arts use battery for portable flash light and current invention for indoor LED lighting and will install or use on one place for majority of time.
b. Construction totally different—Prior construction for simple Direct Current LED circuit. The current invention as all co-inventor's circuit have voltage drop and current limitation and protective circuit for any potential because it need to install indoor of people stay.
c. Foldable prong mean—Prior art no need this because flash light is portable device, no need prong means. The current invention as all Co=#2, Co=#3 all need foldable prong means so can allow people easily carry while emergency use.
d. Filing time difference: The current inventor for hand-held power fail Night light with foldable prong means since the Electro-luminescent power fail night light on 2005, and all series filing for LED power fail Night light on 2010 of Co-#01, Co-#02, and other filing continue filing so the current invention's parent filing are 3-4 years earlier than the Mr. Berken's 1st filing on 2008 Oct. 2 of U.S. Pat. No. 7,845,820. So current invention's filing is much earlier than Mr. Berken's.
e. The Berken's invention for the said 3 piece bottom cells batteries that is not enough for people for golden 72 hours illuminations to wait rescue team to come to help.
f. The current invention with extendable length so the unit can become short enough while people in tiny space to wait be saved. The Berken's fixed length is not good for people face the bad environment.

Further more, the current inventions also disclosure the following main features as below.

1. The LED light has sound means consist of;

At least one 1^{st} LED as light source for the said LED light and at least one 2^{nd} LED as light source for Power Fail light or Flash light or Emergency Light.

Each of the said light source has common or separated working system with other light source and connect with circuit means and electric parts & accessories may select from group combination from switch means, sensor means, blue tooth means, motion sensor means, infrared means, photo sensor, remote control means, prong means, USB means, Pigtail means, Desk top means, base means, housing means, extendable housing means, power source, installation means, conductive means, resilient conduction means, USB means, USB plug and receiving means, Pigtail means, Adaptor means, transformer means, false prong means, sound means, whistle means, removable LED units, movable LED units, connector means, quickly assembly means, screw means, snap tight means, physical fitting means to has 1^{st} LED light source supply area illumination may in the form of LED Night light, LED light fixture, LED under cabinet light, LED Wall Cover light, LED Camping light, LED remote control light, LED Blue Tooth light, LED motions sensor light, LED garden light, LED Desk Lamp, LED security light, LED entrance light, LED garage light for indoor use purpose and has the 2^{nd} function by the said 2^{nd} LED light source for Power Fail, Emergency light, Flash light, evacuation light.

The said 1^{st} and 2^{nd} light source connect with the said circuit means and power source which may selected from group combination including Alternative Power from wall outlets (AC) or Direct current power (DC) from USB or batteries or solar power, wind power, chemical power, DC power storage means, or any other market available energy means to make the said LEDs to turn on under predetermined functions, performance, effects and color, brightness, time period, time delay.

The improvement including:

The said 1^{st} light source application is non-portable device which unable to let people to carry while walking or moving to offer the illumination has changeable directions, height, distance, focus features. The Pt light source is for a certain location or position or area for a period of time installation to offer the light illumination.

The said at least one of the sound means or siren means arranged within, fix, install, add-on, clip-on, attach-on, snap-on, twist-on, glue-on, revit-on the said LED power fail light.

The said sound means can create a very big sound to let people hear for preferred distance, block-means, mud, sand, walls, roof, cement, concrete, brick, wood, or any other material which may used for house, building, office, playground, residence where the human stay area, place.

The said sound means or siren means is a non-power operated device which only operated by mouth, hand, feet, arms, legs of human body. The said non-power operated means the said sound means or siren means is not work for energy storage means, battery means, electric current means which has the too limited time period can be operated for people face the crisis, hazard, emergency condition because energy storage means is too short time for create loud enough voice, sound, signal to the rescue teams.

2. The LED light has more than 2 functions consist of;

At least one 1^{st} LED and 2^{nd} LED as light source connect with circuit mean and electric parts & accessories which may select from group combination including switch mean, sensor means, blue tooth means, remote control means, motion sensor means, foldable prong, extendable housing means, snap tight housing parts, 2^{nd} function device, 2^{nd} light device to make the said 1^{st} and 2^{nd} LED to turn on under predetermined time, duration, color, brightness to get light effects.

The said 1^{st} LED is powered from wall outlets or USB outlets, extension cord, power strip, Transformer power, adaptor power which has relation with the said Alternative current (AC) has selected contact means from desired group combination of prong, USB means, pigtail means, conductive means, wire means, resilient conductive means to working with the said circuit means and electric parts & accessories.

The said 2^{nd} LED is powered from the batteries means, energy storage means, chemical energy means, wind power, solar power, inverter, transformer, adaptor means which has relation with the said Direct current (DC) has contact means may selected from group combination of conducive metal piece, battery bracket, battery terminals, battery rack, battery container, wire means, soldering means, spring contract, resilient conductive means work with the said circuit means and electric parts & accessories.

The said 1^{st} LED preferred one of the selection from night light, desk top LED light, Plug-in LED light, LED Plug-In Wall cover Light, LED desk-top accent light, LED remote control light, LED motion sensor light, LED Blue tooth light, LED Light fixture for the said non-portable use which connect with Alternative current directly or non-directly working with the said circuit means and electric parts & accessories to offer the area(s) illumination.

The said 2^{nd} LED preferred one of the selection from LED power fail light, LED, emergency light, evacuation light, LED torch, LED flash light, LED become light which connected with Direct Current directly or non-directly working with the said circuit means and electric parts & accessories to offer the light beams for user.

The improvement including:

At least one sound means or siren means arranged within or add-on or attach-on or install or arrange-on the said LED light. The said sound means is operated by human's mouth, hand, foot, leg, breath to make load sound for preferred volume to let people to hear for far distance, under construction material, wood, sand, brick, Cement, concrete, mud, falling staff.

The said sound means can non-removable or removable from the said LED light.

3. The Wall cover LED light device consist of

At least one of the 1^{st} LED as light source within the housing for the Night light. At least one of the 2^{nd} LED as power fail light, or emergency light, or evacuation light which can fix on or remove from the housing.

At least one of prong means to insert into wall outlets or use conductive means to connect with wall outlets inner unit to get electric current and connect with circuit means, switch means, sensor means, control means, remote control means, Blue tooth means, infra-red means, electric parts & accessories, resilient conductive means, LED rotating means, wire means to make the said 1^{st} LED for night light function and make the said 2^{nd} LED as power fail light, or flash light, or emergency light, or evacuation light or any desired combination of listed applications.

The said Wall Cover LED light device at least has more than 1 function including night light and power fail light or emergency light or evacuation light.

The improvement including:

The said Wall cover LED light has preferred parts and accessories selected from group combination from screw means, connect means, fix means, fasten means, quickly connector means to replace the original wall cover plate and install the current wall cover LED light on the existing wall's outlet inner holes which for standard 2 oval-shape outlets has 1 center hole & 2 top-low holes or for square-shape outlets only has 2 holes on top-low for people to hold the current wall LED light on preferred holes for safety installation.

The wall cover LED light also has built-in moveable-piece to make the said Wall cover LED light can fit for standard outlets (2 oval-like receptacles) or decora outlets (square-like has 2 receptacles) inner kits. The said moveable-piece which can stay on the said Wall cover LED light while install for the 2 oval-like shape outlets or move-out the movable-piece while the said wall cover LED light install for the rectangular-like outlets.

The wall cover LED light also has at least one conductive prong means and/or false prong means insert into existing inner outlets to get electric power.

The Wall cover LED light's 1^{st} LED night light can arrange on anywhere of the similar size of the original wall cover plate or further more to has other space extend from each side of the original wall cover plate including Top, low, left side or right side.

The Wall cover LED light has at least Night light and power fail light function or add more functions may selected from group combination from whistle device, sound device operated by human body, USB Charger, Remote control device, Blue tooth device, infra-red device, motion sensor device, air Fresher device, time device, project device, power outlets device, fiber optics device, motor device, weather device.

4. The LED power fail light has whistle means consist;
At least one 1^{st} LED as light source for the Night light and powered by Alternative current source from Prong means, USB means, pigtail means, Electric wires means to make the 1^{st} LED turn on under predetermined Function, effects, performance.
At least one 2^{nd} LED as light source for the power fail light and powered by

Direct current source from batteries, energy storage means, chemical power means, solar power means, adaptor means, transformer means, inverter means to make the 2^{nd} LED turn on under predetermined function, effects, Performance.
The said LED power fail light has built-in, add-on, snap-on, attach-on whistle means to create a big volume sound to let people hear for desired distance, or passing though building material or equivalent functions while people needed for any bad conditions.

From FIG. 1 and FIG. 1-12 and FIG. 1-2 and FIG. 1-3 can see the preferred 1^{st} embodiment has the sound means here as whistle on the top of the LED light unit which may in the permanently install or snap-on or add-on the top of the said LED light. The Fig shown the Whistle ae use the whistle base to snap-on to add-on the top of the LED light extendable tube which the extendable tube can extend out from the body tube while needed it for longer length such as make a traffic control or evacuation direction on emergency use. The said 1^{st} Embodiment prefer has the foldable prong means to allow the said LED light can plug-in on wall outlets, power strip, extension cord, or wheel power cord to get the Alternative current from these different power source and make the said LED light for Night light function on normal days. While the LED light act as Night light it has the normal night light which may has photo sensor, motion sensor, remote control, blue tooth, infra-red or other switch means, sensor means, trigger means, IC chip, multiple LEDs, More than one LED, more than one reflective means, more than one functions, more than optic means as the co-inventor variety of the prior arts issued or co-pending as listed on top of the background for all these continuously or CIP filing or Division filing contents.

From FIG. 1-1 and FIG. 1-2 shown the LED light has shorter body because no need so long length for night light purpose. The retractable tube design also can create a lot of different Function. while it shorten can be a night light. While it become longer or extend length can become a baton to give people which direction to move or car driving direction. Also can show the location. From FIG. 1-1 see the side view how to make the Tubular LED light for different length and how to make the prong means foldable so can easily fold the prong while the LED light need to hand carry while need to use the 2^{nd} LED light source. At the 1st light source application, the LED light is fix on the certain location, or place, or area to offer daily work without moving so it is non-portable items while people moving. However, while the 2^{nd} LED light source been use normally for emergency, hazard, earth quake, flood, Hurricane . . . so the prong need to fold-up and the unit become a portable device to let people carry with them or use for illumination or call for help by Big Volume sound by whistle means so the people throat will not get hurts for screaming.

From FIG. 103 shown the Battery cover so can easily replace batteries while needed. The battery cover has screw to fasten to prevent kids to take out batteries for swallow to cause dangerous.

From the FIG. 2, FIG. 3 and FIG. 4-1 and FIG. 4-2 has details construction with all parts name and how to assembly together for the 1^{st} Embodiment. It is very clear and details for all arrangements on drawing so do not discuss details here.

From FIG. 5-1 shown the LED 1 and LED 2 function and the holes on the said Wall Cover LED light has different construction and designs including
(1) more than 2 functions or add more function including outlets, USB Charger, USB hubs (Signal delivery, not the Current delivery which min from 500 ma up to 10,000 ma), air fresher, moisture spray, bug repeller, movable LED light units (co-inventor's issued patents), project light, project image, time display, time piece, . . . as background details.
(2) more than one screw holes—depend on market requirement for universal unit has to have 3 screw holes so can fit for the 1. Standard outlets with 2 oval-like shape receptacles has center and top/low screw holes. (or) 2. Decora outlets which has 2 outlets receptacles in a rectangular shape but only have top and low screw holes.
(3) has decorative cover to cover screw holes (not shown) which is tiny plastic cover arrange to put on top of the holes so it look no visible holes to spoil the pretty appearance.
(4) use the Hing-type optics lens to cover screw holes such as the FIG. 7-2 and FIG. 7-3 which use the Optics lens with sand blaster treatment or the opaque lens to cover the inner top screw hole. It also easily to allow people to add the screw on top screw holes while use the Decora outlets unit which has no center screw holes.
(5) The USB hub which only carry the digital data not carry 500-10,000 ma current to charge the other electric device.
(6) The USB Charger which has current to charge other electric device such as smart phone, computer, camera, digital device, music player, ipad, iphone, communication or computer or consumer products and other electric device need use electric current to drive.
   So the current invention for Wall cover LED light not only as the drawing show the limited embodiments, it is appreciated any the plug-in or wired or other electric connection Wall Cover LED light should still fall within the current invention scope basin on the back ground for co-inventor issued or co-pending filing all should be consider as co-inventor prior art disclosure including more than 1 LED, more than 1 function, More than 1 optics means, more than 1 features for any plug-in or desk top AC or DC applications.
   From FIG. 7-1 and FIG. 7-4 shown the 2 different major market outlets units which has different number of screw holes to allow people to fasten, or fix the wall cover plate or the co-inventor's earlier US patent multiple cover light U.S. Pat. No. 7,318,653 or current pending filing for Wall Cover has USB Charger function U.S. Ser. No. 12/910,295.
   From the FIG. 7-3 and FIG. 7-4 shown the same Wall Cover LED light has the optics lens on top which is hinge-construction can flap over and flap down (rotating)) so can allow people to add top screw though top screw hole. It also show the Wall Cover LED light is universal to fit for the 2 major outlets unit (1) FIG. 7-1 standard outlet unit and (2) FIG. 7-4 Decora outlet unit.
   From FIG. 7-5 and its notes show the moveable piece which is key for make the current wall cover LED light become universal to fit both the (1) Standard and (2) Decora outlet units. The movable piece can fix on the inner side of the wall cover LED light and also can push it out while you do not need this movable Piece while people house has Decora outlet unit. This is very simple concept but very important for people to buy one and fit all for Universal product.
   From FIG. 7-6 shown the Wall Cover LED light is not limited for the size similar with the existing wall cover plate for 2 oval-shaped opening type. The current invention said the wall cover means all kind of wall cover further more can do the 1^{st} LED and 2^{nd} LED function for all kind of wall cover plate shape same size or much bigger which can extend from all sides from market available wall cover plate so can make like SIDE Light design.
   It also appreciated the wall cover LED light is not only limited for only prong means to build the electric delivery from the existing wall AC power source. It can use conductive wire as FIG. 7-6 or other elastic conductive means such as copper contact on the top-end of elastic plastic pole to contact the FIG. 7-1 and FIG. 7-4 two sides positive and negative screw to build the electric delivery from power source.

It is appreciated the current invention for the wall cover LED light has the at least one 1^{st} LED light source to act as normal any LED light function and at least one of 2^{nd} LED light source to act as power fail or emergency light or evacuation light or add more function by any conductive means and electric parts & Accessories for create good applications Wall Cover LED light as above all disclosure and all co-inventor issued or co-pending as all prior arts in consideration and scope of the current filing case.

1. The LED light has sound means consist of;
At least one 1^{st} LED as light source for the said LED light and at least one 2nd LED as light source for Power Fail light or Flash light or Emergency Light.
Each of the said light source has common or separated working system with other light source and connect with circuit means and electric parts & accessories may select from group combination from switch means, sensor means, blue tooth means, motion sensor means, infrared means, photo sensor, remote control means, prong means, USB means, Pigtail means, Desk top means, base means, housing means, extendable housing means, power source, installation means, conductive means, resilient conduction means, USB means, USB plug and receiving means, Pigtail means, Adaptor means, transformer means, false prong means, sound means, whistle means, removable LED units, movable LED units, connector means, quickly assembly means, screw means, snap tight means, physical fitting means to has 1^{st} LED light source supply area illumination may in the form of LED Night light, LED light fixture, LED under cabinet light, LED Wall Cover light, LED Camping light, LED remote control light, LED Blue Tooth light, LED motions sensor light, LED garden light, LED Desk Lamp, LED security light, LED entrance light, LED garage light for indoor use purpose and has the 2^{nd} function by the said 2^{nd} LED light source for Power Fail, Emergency light, Flash light, evacuation light.
The said 1^{st} and 2^{nd} light source connect with the said circuit means and power source which may selected from group combination including Alternative Power from wall outlets (AC) or Direct current power (DC) from USB or batteries or solar power, wind power, chemical power, DC power storage means, or any other market available energy means to make the said LEDs to turn on under predetermined functions, performance, effects and color, brightness, time period, time delay.
The improvement including:
The said 1^{st} light source application is non-portable device which unable to let people to carry while walking or moving to offer the illumination has changeable directions, height, distance, focus features. The 1^{st} light source is for a certain location or position or area for a period of time installation to offer the light illumination.
The said at least one of the sound means or siren means arranged within, fix, install, add-on, clip-on, attach-on, snap-on, twist-on, glue-on, revit-on the said LED power fail light.
The said sound means can create a very big sound to let people hear for preferred distance, block-means, mud, sand, walls, roof, cement, concrete, brick, wood, or any other material which may used for house, building, office, playground, residence where the human stay area, place.
The said sound means or siren means is a non-power operated device which only operated by mouth, hand, feet, arms, legs of human body. The said non-power operated means the said sound means or siren means is not work for energy storage means, battery means, electric current means which has the too limited time period can be operated for people face the crisis, hazard, emergency condition because energy storage means is too short time for create loud enough voice, sound, signal to the rescue teams.

2. The LED light has more than 2 functions consist of;
At least one 1^{st} LED and 2^{nd} LED as light source connect with circuit mean and electric parts & accessories which may select from group combination including switch mean, sensor means, blue tooth means, remote control means, motion sensor means, foldable prong, extendable housing means, snap tight housing parts, 2^{nd} function device, 2^{nd} light device to make the said 1st and 2^{nd} LED to turn on under predetermined time, duration, color, brightness to get light effects.
The said 1^{st} LED is powered from wall outlets or USB outlets, extension cord, power strip, Transformer power, adaptor power which has relation with the said Alternative current (AC) has selected contact means from desired group combination of prong, USB means, pigtail means, conductive means, wire means, resilient conductive means to working with the said circuit means and electric parts & accessories.
The said 2^{nd} LED is powered from the batteries means, energy storage means, chemical energy means, wind power, solar power, inverter, transformer, adaptor means which has relation with the said Direct current (DC) has contact means may selected from group combination of conducive metal piece, battery bracket, battery terminals, battery rack, battery container, wire means, soldering means, spring contract, resilient conductive means work with the said circuit means and electric parts & accessories.
The said Pt LED preferred one of the selection from night light, desk top LED light, Plug-in LED light, LED Plug-In Wall cover Light, LED desk-top accent light, LED remote control light, LED motion sensor light, LED Blue tooth light, LED Light fixture for the said non-portable use which connect with Alternative current directly or non-directly working with the said circuit means and electric parts & accessories to offer the area(s) illumination.
The said 2^{nd} LED preferred one of the selection from LED power fail light, LED, emergency light, evacuation light, LED torch, LED flash light, LED become light which connected with Direct Current directly or non-directly working with the said circuit means and electric parts & accessories to offer the light beams for user.
The improvement including:
At least one sound means or siren means arranged within or add-on or attach-on or install or arrange-on the said LED light. The said sound means is operated by human's mouth, hand, foot, leg, breath to make load sound for preferred volume to let people to hear for far distance, under construction material, wood, sand, brick, Cement, concrete, mud, falling staff.
The said sound means can non-removable or removable from the said LED light.

3. The Wall cover LED light device consist of
At least one of the 1st LED as light source within the housing for the Night light. At least one of the 2^{nd} LED as power fail light, or emergency light, or evacuation light which can fix on or remove from the housing.
At least one of prong means to insert into wall outlets or use conductive means to connect with wall outlets inner unit to get electric current and connect with circuit means, switch means, sensor means, control means, remote control means, Blue tooth means, infra-red means, electric parts & accessories, resilient conductive means, LED rotating means, wire means to make the said 1^{st} LED for night light function and make the said 2^{nd} LED as power fail light, or flash light, or emergency light, or evacuation light or any desired combination of listed applications.
The said Wall Cover LED light device at least has more than 1 function including night light and power fail light or emergency light or evacuation light.
The improvement including:
The said Wall cover LED light has preferred parts and accessories selected from group combination from screw means, connect means, fix means, fasten means, quickly connector means to replace the original wall cover plate and install the current wall cover LED light on the existing wall's outlet inner holes which for standard 2 oval-shape outlets has 1 center hole & 2 top-low holes or for square-shape outlets only has 2 holes on top-low for people to hold the current wall LED light on preferred holes for safety installation.
The wall cover LED light also has built-in moveable-piece to make the said Wall cover LED light can fit for standard outlets (2 oval-like receptacles) or decora outlets (square-like has 2 receptacles) inner kits. The said moveable-piece which can stay on the said Wall cover LED light while install for the 2 oval-like shape outlets or move-out the movable-piece while the said wall cover LED light install for the rectangular-like outlets.
The wall cover LED light also has at least one conductive prong means and/or false prong means insert into existing inner outlets to get electric power.
The Wall cover LED light's 1^{st} LED night light can arrange on anywhere of the similar size of the original wall cover plate or further more to has other space extend from each side of the original wall cover plate including Top, low, left side or right side.
The Wall cover LED light has at least Night light and power fail light function or add more functions may selected from group combination from whistle device, sound device operated by human body, USB Charger, Remote control device, Blue tooth device, infra-red device, motion sensor device, air Fresher device, time device, project device, power outlets device, fiber optics device, motor device, weather device.

4. The LED power fail light has whistle means consist;
At least one 1^{st} LED as light source for the Night light and powered by Alternative current source from Prong means, USB means, pigtail means, Electric wires means to make the 1^{st} LED turn on under predetermined Function, effects, performance.
At least one 2^{nd} LED as light source for the power fail light and powered by Direct current source from batteries, energy storage means, chemical power means, solar power means, adaptor means, transformer means, inverter means to make the 2^{nd} LED turn on under predetermined function, effects, Performance.
The said LED power fail light has built-in, add-on, snap-on, attach-on whistle means to create a big volume sound to let people hear for desired distance, or passing though building material or equivalent functions while people needed for any bad conditions.
